(19) United States
(12) Patent Application Publication
(10) Pub. No.: US 2018/0114268 A1
(43) Pub. Date: Apr. 26, 2018

(54) METHODS AND APPARATUS FOR CONDUCTING TRADE EXCHANGE PURCHASE AND SALE TRANSACTIONS USING PARTIAL VIRTUAL CURRENCY AND PARTIAL CASH PAYMENTS

(71) Applicants: Hassan S. Abhari, saratoga, CA (US); Illia Matviienko, berlin (DE)

(72) Inventors: Hassan S. Abhari, saratoga, CA (US); Illia Matviienko, berlin (DE)

(21) Appl. No.: 15/591,097

(22) Filed: May 9, 2017

Related U.S. Application Data
(60) Provisional application No. 62/334,415, filed on May 10, 2016.

(51) Int. Cl. G06Q 40/04

(52) U.S. Cl. CPC G06Q 40/04; G06Q 20/0655

(57) ABSTRACT

In one aspect, a virtual-currency barter network process includes a step that provides, with a server of the virtual-currency barter network, a first web page comprising a commercial object for sale, wherein the commercial object is purchasable using a virtual currency/cash hybrid transaction, and wherein the web page comprises a virtual barter button. The process includes a step that detects that a buyer clicks on the virtual barter button. The process includes a step that provides a second web page comprising a set of payment options input elements. The process includes a step that receives, via the payment options input elements, a ratio of a virtual currency portion and a cash portion of the virtual currency/cash hybrid transaction. The process includes a step that determines that the buyer has sufficient virtual currency funds within the virtual-currency barter network to satisfy the virtual currency portion of the virtual currency/cash hybrid transaction. The process includes a step that determines that the buyer has a sufficient cash funds within the virtual-currency barter network to satisfy the cash portion of the virtual currency/cash hybrid transaction. The process includes a step that receives an acceptance from the seller of the virtual currency/cash hybrid transaction. The process includes a step that purchasing the commercial object with the virtual currency portion and the cash portion of the virtual currency/cash hybrid transaction.

### CROSS-REFERENCE TO RELATED APPLICATIONS

This application claims priority to U.S. Provisional Application No. 62/334,415, titled and Methods and Apparatus for Conducting Trade Exchange Purchase and Sale Transactions Using Partial Trade and Partial Cash Payments filed on 10 May 2016. This provisional application is incorporated by reference in its entirety.

### BACKGROUND OF THE INVENTION

### 1. Field

This application relates to a system, article of manufacture, and method for conducting trade exchange purchase and sale transactions using partial trade and partial cash payments.

### 2. Related Art

Many businesses and service providers carry excess capacity in the form of goods or services which would otherwise be unsold. Alternative methods of payment are desirable by sellers that would otherwise have unsold inventory, and the same is true by buyers that have an interest in purchasing goods and services in various non-cash forms of payment. Accordingly, it would be desirable to have available systems and methods for purchasing goods and services in various non-cash forms of payment.

### BRIEF SUMMARY OF THE INVENTION

In one aspect, a virtual-currency barter network process includes a step that provides, with a server of the virtual-currency barter network, a first web page comprising a commercial object for sale, wherein the commercial object is purchasable using a virtual currency/cash hybrid transaction, and wherein the web page comprises a virtual barter button. The process includes a step that detects that a buyer clicks on the virtual barter button. The process includes a step that provides a second web page comprising a set of payment options input elements. The process includes a step that receives, via the payment options input elements, a ratio of a virtual currency portion and a cash portion of the virtual currency/cash hybrid transaction. The process includes a step that determines that the buyer has sufficient virtual currency funds within the virtual-currency barter network to satisfy the virtual currency portion of the virtual currency/cash hybrid transaction. The process includes a step that determines that the buyer has a sufficient cash funds within the virtual-currency barter network to satisfy the cash portion of the virtual currency/cash hybrid transaction. The process includes a step that receives an acceptance from the seller of the virtual currency/cash hybrid transaction. The process includes a step that purchasing the commercial object with the virtual currency portion and the cash portion of the virtual currency/cash hybrid transaction.

### BRIEF DESCRIPTION OF THE DRAWINGS

FIG. 1 illustrates an example system for implementing a virtual-currency barter network, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an information flow between a virtual-currency barter network and external actors, according to some embodiments.

FIG. 5 illustrates an example module for implementing virtual-currency barter network server(s), according to some embodiments.

FIG. 6 illustrates an example process for implementing a virtual-currency barter network, according to some embodiments.

FIG. 7 illustrates an example set of workflows of a virtual-currency barter network, according to some embodiments.

FIGS. 8 A-D illustrate an example set of screen shots of Barter buttons, according to some embodiments.

FIG. 9 illustrates an example table with input parameters for managing a Barter button workflow, according to some embodiments.

FIG. 10 illustrates an example Barter button workflow, according to some embodiments.

FIG. 11 illustrates an example transaction management workflow, according to some embodiments.

FIG. 12 illustrates an example transaction management flow, according to some embodiments.

FIG. 13 illustrates another example transaction processing workflow, according to some embodiments.

FIG. 14 illustrates an example of a virtual-currency barter network process, according to some embodiments.

The Figures described above are a representative set, and are not an exhaustive with respect to embodying the invention.

### DESCRIPTION

Disclosed are a system, method, and article of manufacture for conducting trade exchange purchase and sale transactions using partial virtual currency and partial cash payments. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cash can be money in the physical form of currency, such as banknotes and coins.

Cloud computing can involve deploying groups of remote servers and/or software networks that allow centralized data storage and online access to computer services or resources. These groups of remote serves and/or software networks can be a collection of remote computing services.

Cryptocurrency can be a digital asset designed to work as a medium of exchange using cryptography to secure the transactions and to control the creation of additional units of the currency. Cryptocurrencies can be a subset of digital currencies.

Digital currency can exhibit properties similar to physical currencies, but allows for instantaneous transactions (e.g. assuming networking and processing latencies) and borderless transfer-of-ownership. Examples can include virtual currencies and cryptocurrencies, among others.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Virtual currency can be a type of unregulated, digital money, which is issued and usually controlled by its developers, and used and accepted among the members of a specific virtual community.

Example Computer Architecture and Systems

The systems described herein create an opportunity for a group of buyers and sellers to buy and sell from one another in a form of a mutually agreed upon currency (e.g. referred to as Trade Dollars, credits, or using other appropriate terms) and, a combination of Trade Dollars and cash while utilizing computerized payment processing systems.

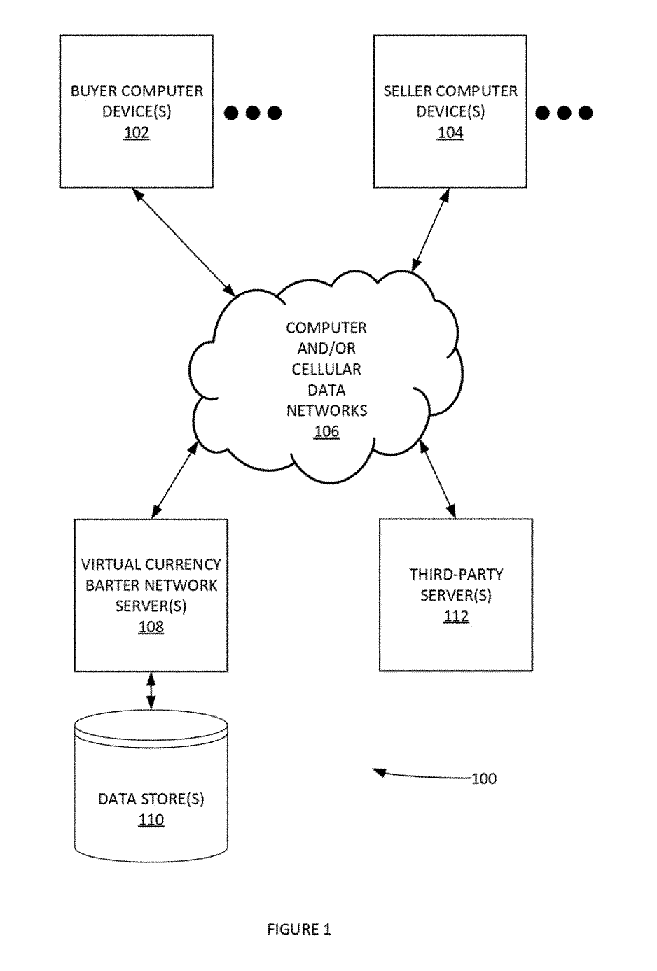

FIG. 1 illustrates an example virtual-currency barter network 100 (Network 100) for implementing a virtual-currency barter network, according to some embodiments. A group of buyers and sellers may join a trade/barter exchange system or trade/barter exchange network for various reasons, including but not limited to, buy and sell excess capacity, earn new customers, acquire goods or services deploying less cash, etc. These trade and barter exchange systems can issue mutually agreed upon credits, such as Trade Dollars (e.g. symbolized as ‘T$’ herein), that are accepted by all members upon joining. It is noted that the term “Dollar” can be used to refer to currency. One of ordinary skill will recognize that other currencies may be used and that the inventions illustrated herein may also be used in mixed-currency environments and transactions, for example, environments wherein Euros, Dollars, Bitcoins, and Rubles are all considered valid currency. In various embodiments, a Trade Dollar can be a digital currency, virtual currency, cryptocurrency and/or an electronic payment system. An additional discussion of one example of a Trade Dollar is provided infra. In a virtual-currency trade exchange and/or virtual-currency barter network environment (referred to herein as a “Network”), the buyer 102 may pay the seller 104 in form of the T$ that is maintained by the Network 100. The Network 100 can maintain a digitalized ledger of credits (e.g. in data store 110, etc.) and debits for various transactions completed in the Network 100 between various members. The Network 100 may earn a transaction, maintenance, or other fee. The fee earned by the Network 100 may be in the form of transaction fees and/or membership fees to facilitate its services.

In some embodiments, a Trade Dollar can be a virtual currency that exists in the Network 100. A Trade Dollar can be symbolized as ‘T$’. A customer may be given a T$ line of credit when they join according to a Business tier in which the customer resides. These Trade Dollars can be used by customers to buy goods and services from sellers in the Network 100. A customer can preferably earn T$ by selling goods and services to other customers. In some instances, system 100 can enable customers to buy T$ by converting cash to T$.

In one example, Trade Dollars can be used to buy goods and services from any member within the Network 100. In some instances, the Network 100 may also issue a line of credit in the form of Trade Dollars to any eligible member. Negative Trade Dollar lines of credit may be repaid by the member upon selling their goods or services to other members in the Network 100 and thereby earning Trade Dollar credits to offset the negative line of credit.

Trade Dollars may be earned by a seller who could sell goods and services to any other eligible member within the Network 100. For example, a print shop might sell $1,000 worth of printing services to a restaurant where the restaurant would pay the print shop with either T$1000, or partial T$ and Cash, for example, $600 and T$400. It may also be desirable to weight T$ with a ratio to Cash that is different than 1:1. In the described $600 and T$400 transaction, the seller would receive $600 deposited to his designated bank account (or other cash account, as designated by the Buyer computing device(s) 102 (referred to herein as a “Buyer”), the Seller computing device(s) 104 (referred to herein as a “Seller”), and/or the Network 100), and a credit of T$400 in its trade account that is maintained by the Network 100 or an affiliate of the Network 100. In some examples, the print shop would then be able to use the T$400 to purchase other items, for example, plumbing services from another member and delivery services from yet another member. In this example, assume that the plumbing services are in the amount of T$150, and delivery services in the amount of T$50. After such transactions, if no service charges or other charges are applied to the T$ in the print shop's trade account, the print shop would have T$200 remaining. The remaining Trade Dollar credits in seller's account can be used to purchase any other product or service from one or any other member with the Network 100.

In some embodiments, various functionalities of Network 100 can be implemented by Virtual Currency Barter Network Server(s) 108. virtual currency barter network server(s) 106 can provide and/or manage a virtual-currency barter through the orchestration of interaction(s) between buyers 102 and/or sellers 104 and includes website, backend modules, and mobile application. In one alternative embodiment, the Virtual Currency Barter Network server(s) 108 can provided one or more websites that orchestrate much or all of the interaction between buyers and sellers with support from Virtual Currency Barter Network server(s) 108, for example, a barter button and related software. Virtual Currency Barter Network server(s) 108 can provide various modules such as, inter alia, Billing, Barter button, Invite button, business search of the system to fulfill service's business logic, etc. These can be accessible via a website and/or mobile-device application. Virtual Currency Barter Network Server(s) 108 can provide/manage an API that can be used by other programs/systems to interact with Network 100 and/or its modules. API 106 can also access other programs/systems on behalf of Network 100 and/or its modules.

Network 100 can include third-party servers 112. Third-party servers 112 can provide various services (e.g. commercial listings, search engines, etc.). Third-party servers 112 be an online payment service provider.

Network 100 can be implemented in various computing devices and/or platforms. Portions of Network 100 can be implemented in a mobile device. Portions of system 100 can be implemented in an image projecting device. Portions of Network 100 can be implemented exemplary computing system 200 and/or sample computing environment 300. The analytics and/or machine learning aspects of Network 100 can be implemented in a cloud-computing platform. Network 100 can be a set of modules, which are can be provided as a SaaS (Software as a Service) allowing customers to conduct cash, T$, and/or mixed cash and T$ trading with each other.

Network 100 can be a trading platform for members (e.g. customers). One aspect of the uniqueness of Network 100 is in its approach to payments between members. The process of trading may be referred to as transactions. In an example embodiment, each transaction can occur between two members, although in less common scenarios additional members (and possibly nonmembers) may be involved in a transaction. In an example embodiment, one of the involved members is called Buyer and the other one is Seller.

Each transaction can be provided partially in trade dollars and partially in cash. The ratio of cash to trade dollars can vary per transaction as agreed by the seller and the buyer. In one embodiment, the default ratio is sixty percent (60%) cash and forty percent (40%) trade dollars. Network 100 can provide each customer with a line of credit in Trade Dollars. The members can spend the Trade Dollars on buying goods and/or services from other members. Preferably, members can earn and repay their credit by selling to other members. Trade dollars earned by members may then be spent when buying from other members in Network 100.

Network 100 can include various network security systems. Network security can consist of the policies and practices adopted to prevent and monitor unauthorized access, misuse, modification, or denial of a computer network and network-accessible resources. Network security involves the authorization of access to data in a network, which is controlled by the network administrator. Users can choose and/or are assigned an identifier and password or other authenticating information that allows them access to information and programs within their authority.

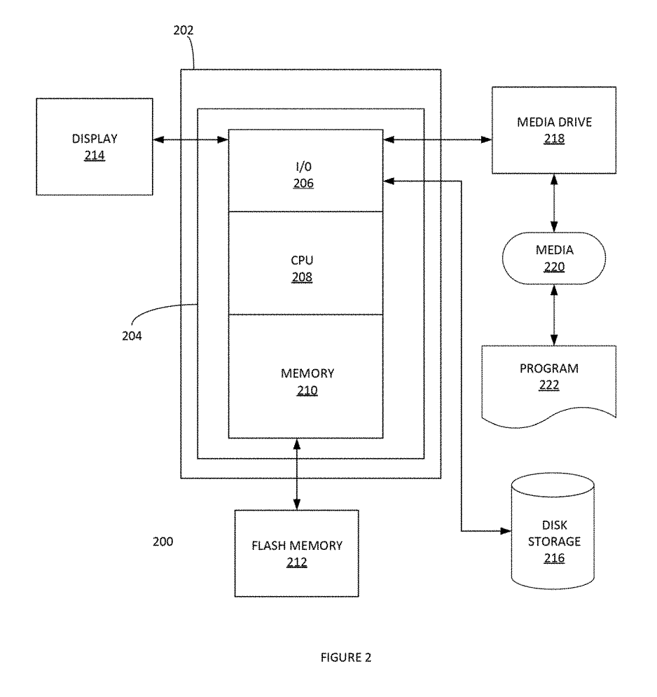

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

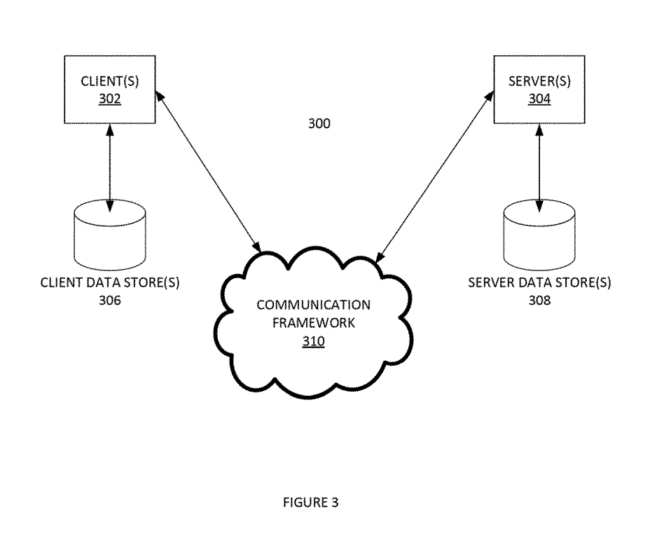

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

In some embodiments, systems 200 and 300 can be integrated can be configured as follows. A suitable environment for implementing various aspects of the claimed subject matter includes a computer. The computer includes a processing unit, a system memory, a codec, and a system bus. The system bus can couple system components including, but not limited to, the system memory to the processing unit. The processing unit can be any of various available processors. Dual microprocessors and other multiprocessor architectures also can be employed as the processing unit.

The system bus can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory includes volatile memory and non-volatile memory. The basic input/output system (BIOS), containing the basic routines to transfer information between elements within the computer, such as during start-up, is stored in non-volatile memory. By way of illustration, and not limitation, non-volatile memory can include read only memory (ROM), programmable ROM (PROM), electrically programmable ROM (EPROM), electrically erasable programmable ROM (EEPROM), or flash memory. Volatile memory includes random access memory (RAM), which acts as external cache memory. According to present aspects, the volatile memory may store the write operation retry logic and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer may also include removable/non-removable, volatile/non-volatile computer storage media, for example, a disk storage. Disk storage includes, but is not limited to, devices like a magnetic disk drive, solid state disk (SSD) floppy disk drive, tape drive, Jaz drive, Zip drive, LS-100 drive, flash memory card, or memory stick. In addition, disk storage can include storage media separately or in combination with other storage media including, but not limited to, an optical disk drive such as a compact disk ROM device (CD-ROM), CD recordable drive (CD-R Drive), CD rewritable drive (CD-RW Drive), a digital versatile disk ROM drive (DVD-ROM), DVD-RW, or Blu Ray disc. To facilitate connection of the disk storage devices to the system bus, a removable or non-removable interface is typically used.

It is to be appreciated that software is present that acts as an intermediary between users and the basic computer resources described in the suitable operating environment. Such software includes an operating system. Operating system, which can be stored on disk storage, acts to control and allocate resources of the computer system. Applications take advantage of the management of resources by operating system through program modules, and program data, such as the boot/shutdown transaction table and the like, stored either in system memory or on disk storage. It is to be appreciated that the claimed subject matter can be implemented with various operating systems or combinations of operating systems.

A user enters commands or information into the computer through input device(s). Input devices include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit through the system bus via interface port(s). Interface port(s) include, for example, a serial port, a parallel port, a game port, and a universal serial bus (USB). Output device(s) use some of the same type of ports as input device(s). Thus, for example, a USB port may be used to provide input to computer, and to output information from computer to an output device. Output adapter is provided to illustrate that there are some output devices like monitors, speakers, and printers, among other output devices, which require special adapters. The output adapters include, by way of illustration and not limitation, video and sound cards that provide a means of connection between the output device and the system bus. It should be noted that other devices and/or systems of devices provide both input and output capabilities such as remote computer(s).

Computer can operate in a networked environment using logical connections to one or more remote computers, such as remote computer(s). The remote computer(s) can be a personal computer, a server, a client, a processing center, a cloud computing center, a certificate authority, a router, a network PC, a workstation, a microprocessor based appliance, a peer device, a smart phone, a tablet, or other network node, and typically includes many of the elements described relative to computer. For purposes of brevity, only a memory storage device is described with remote computer(s). Remote computer(s) is logically connected to computer through a network interface and then connected via communication connection(s). Network interface encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) are the hardware/software employed to connect the network interface to the bus. While communication connection may be inside computer, it can also be external to computer. The hardware/software necessary for connection to the network interface includes, for exemplary purposes only, internal and external technologies such as, modems including regular telephone grade modems, cable modems and DSL modems, ISDN adapters, and wired and wireless Ethernet cards, hubs, and routers.

A computing environment (or system) may be used in accordance with the subject specification. The environment includes one or more client(s), which can include an application or a system that accesses a service on the server. The client(s) can be hardware and/or software (e.g., threads, processes, computing devices). The client(s) can house cookie(s) and/or associated contextual information by employing the specification, for example.

The system also includes one or more server(s). The server(s) can also be hardware or hardware in combination with software (e.g., threads, processes, computing devices). One possible communication between a client and a server can be in the form of a data packet adapted to be transmitted between two or more computer processes where the data packet contains, for example, a certificate. The data packet can include a cookie and/or associated contextual information, for example. The system includes a communication framework (e.g., a global communication network such as the Internet) that can be employed to facilitate communications between the client(s) and the server(s).

Communications can be facilitated via a wired (including optical fiber) and/or wireless technology. The client(s) are operatively connected to one or more client data store(s) that can be employed to store information local to the client(s) (e.g., cookie(s) and/or associated contextual information). Similarly, the server(s) are operatively connected to one or more server data store(s) that can be employed to store information local to the servers.

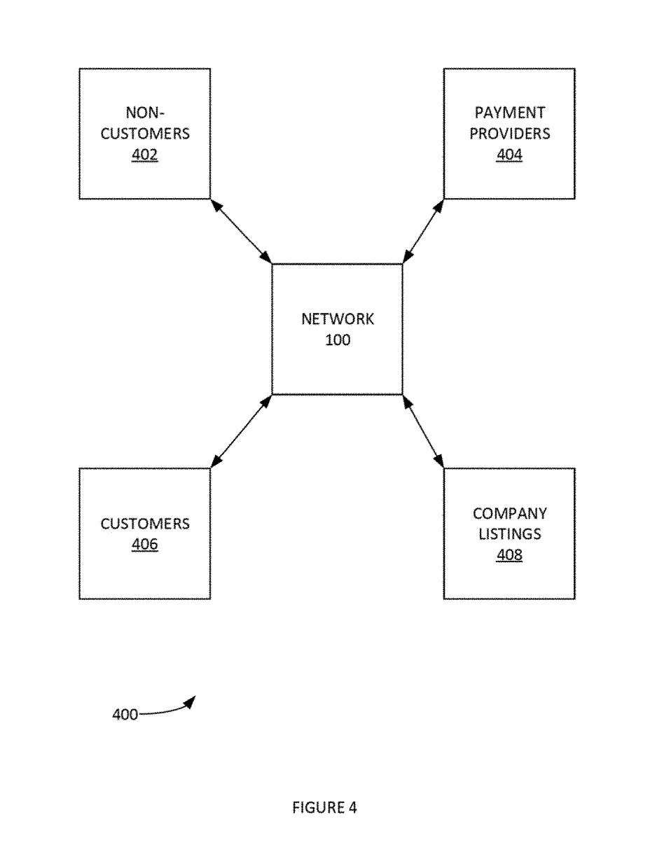

FIG. 4 illustrates an information flow 400 between entities of Network 100 and external actors, according to some embodiments. Information flow 400 illustrates a means for current customers of Network 100 to invite other external entities (e.g. Non-Customers 402) to become members. Network 100 can invite Non-Customers 402 access Network 100. Accordingly, Network 100 can make certain aspects of its virtual-currency barter network available to Non-Customers 402. Non-Customers 402 can register with Network 100. Network 100 can also initiate transactions between member entities with Payment Providers 404. Payment Providers 404 can implement payments and provide payment/transaction information to Network 100. Customers 406 can initiate and accept transactions using Network 100. Network 100 can notify Customers 406 of payment/transaction information. Company Listings 408 can include entities that provide various goods and/or services available in Network 100. Company Listings 408 can also include entities that exist outside of Network 100 (e.g. Yelp®, Yellow Pages®, etc.) along with information about concomitant goods and/or services offered by said external entities. Network 100 can proactively request Company Listings 408 on a periodic basis. Network 100 can also integrate with third-party payment providers to implement cash-processing transactions. These third-party payment providers can process the cash portion of a virtual currency/cash hybrid transaction. In some embodiments, Virtual Currency Barter Network server(s) 108 can be utilized to implement the functions of Network 100 in information flow 400.

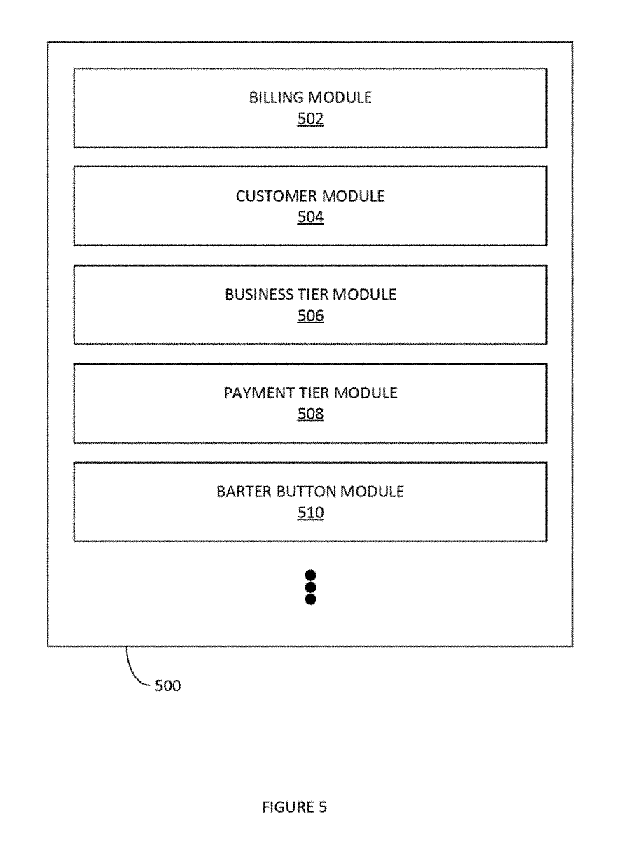

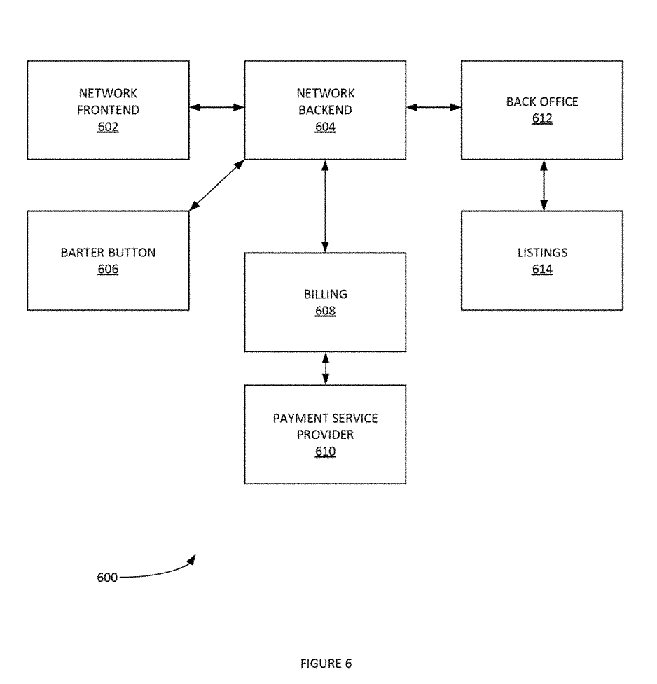

FIG. 5 illustrates an example module 500 for implementing virtual-currency barter network server(s), according to some embodiments. Billing module 502 can calculate a customers' account states, tracks transactions between customers, manages distribution of fees and/or cuts on payments for both virtual currency (e.g., credits or T$) and/or cash. Various calculations can be performed according to direction provided by a customer's tier (e.g. customer module 504, etc.).

Customer module 504 can manage actions by a customer (Member, Buyer(s), or Seller(s)). A customer can be a business (e.g. enterprise, small/medium business (SMB), contractor/freelancer) that is registered in the network 100. A customer can have a profile in the system. Various customers can interact with other customers in the system using customer module 504. For various transactions, one customer can have a seller role and another customer can have a buyer role. In other transactions, customer module 504 can provide for multiple buyers, multiple sellers, lienholders, or other combinations of actors.

Business tier module 506 can enable each customer to have an assigned tier related to the customer's account. Business tier module 506 can be used to determine membership rules for a customer. Business tier module 506 can also be used to determine monthly fee, percentage cuts on transactions, initial setup fees, line of credit, and other status, transaction, or membership privileges or restrictions.

Payment tier module 508 can manage payments within network 100. Payments can be implemented via various entities such as, inter alia: a payment processor, a credit card processing company, WePay® (and/or other online payment service providers), etc. It is noted that WePay® is an online payment service provider in the United States. The company provides a payment API to platform businesses such as crowdfunding sites, marketplaces and small business software. A third-party partner or affiliate can be integrated with network 100. Cash transactions between customers, as well as between the network 100 and customers, through one or more payment providers. Network 100 can store credit card or bank account information of the customers. Network 100 can also facilitate/Implement transactions as well. Network 100 can initiate transactions between customers and the system according to the billing business logic. Such transactions may be routed to Payment tier module 508.

Barter button module 510 can be implemented outside the services of network 100. However, Barter button module 510 can interact with network 100 to facilitate processing of payment transactions for members. Barter button module 510 can manage barter buttons. Barter button module 510 can provide a new type of payment option as an alternative to PayPal®, Credit cards, Wire transfer, Bill me later providers, etc. Barter button module 510 can serve as a marketing instrument to attract new customers during checkout on third party web-sites and e-commerce platforms. Barter button module 510 can be integrated with a web-site, e-commerce platform and/or mobile application by adding a small amount of pre-generated code to the existing code on such platforms. In one embodiment, this code can be unique for each customer, such that one unique barter button is connected to only one unique customer. In other examples, multiple barter buttons can be provided for each customer. The barter button can be pre-configured to integrate with third-party ecommerce software vendors which enable a member to activate a barter button within their shopping cart or online/mobile storefront.

Exemplary Methods

FIG. 6 illustrates an example process 600 for implementing a virtual-currency barter network 600, according to some embodiments. Network Frontend 602 can provide an interface for customers to interact with a virtual-currency barter Network application. Network Frontend 602 can include landing pages a main network user interface (UI). The network UI can enable customers to search for other businesses with which to trade. Network Frontend 602 can enable members to trade with each other and/or interact with other businesses. Network Frontend 602 can provide a customer profile management UI. The customer profile management UI can enable customers to, inter alia: register with the virtual-currency barter service; manage their own data, inventory and/or services they provide; manage their wish list; interact with virtual-currency barter Network account management and/or support.

Barter button 606 can be implemented as a code snippet and/or plugin for e-commerce platforms. In one example, Barter button 606 can include a visual element (e.g. a virtual Barter button) to interact with the virtual-currency barter network system. When the virtual Barter button is clicked, it triggers a ‘Barter button workflow’ that is implemented/managed by Network Backend 604.

Network Backend 604 can orchestrate the operation of the virtual-currency barter network application. Network Backend 604 can manage data consistency. Network Backend 604 track of member's inventory. Network Backend 604 can store customers' profiles and data. Network Backend 604 can serve search queries from Net Frontend 602. Network Backend 604 can integrate with companies' listings services to enrich data of virtual-currency barter network 600. Network Backend 604 manages interaction workflow with a Barter button. Network Backend 604 can track communication between customers. Network Backend 604 can manage transactions workflow. Network Backend 604 can track communication between customers and virtual-currency barter network 600 account and support teams. Network Backend 604 can initiate/manage transactions serviced by Billing module 608.

Billing module 608 can ensure consistency of transactions. Billing module 608 can handle billing of customers. Billing module 608 can manage transaction processing workflow(s). Billing module 608 can initiate cash transactions in external payment processing system (e.g. via payment service provider 610, etc.) according to the workflow. Payment service provider 610 can be an external payment processor (e.g., We Pay®, etc.). External payment provider can store the customers' payment data. Payment service provider 610 can implement cash transactions initiated by Billing module 608.

Back-Office module 612 can provide a UI for a virtual-currency barter network management team. Back-Office module 612 can enable account managers to interact with customers. Back-Office module 612 can enable account managers to manage a customer workflow.

It is noted that virtual-currency barter network members can use credit cards. For example, members provide a credit card to virtual-currency barter network 600 upon joining. In some embodiments, a valid credit card can be on file to process partial trade/cash transactions in the virtual-currency barter network 600. Other embodiments may not require a credit card, but preferably incorporate a secure method of guaranteeing payment. The cash portion of any transaction contemplated by the members may be withdrawn from the member's credit card or other payment method associated with the member account. Any cash refunds by sellers would preferably be credited to the buyer's credit card on file. Payment service provider 610 can be instructed by virtual-currency barter network 600 to credit and debit the member credit card based on the transactions being performed.

Member bank accounts can be managed by virtual-currency barter network 600. In some embodiments, a Selling member can provide a bank account in order to have the cash portion of any transaction deposited into its bank. In other embodiments, different manners of depositing or crediting cash can be employed. A payment processor used by virtual-currency barter network 600 may process the credit card payments and deposit the cash portion of any transaction into the seller's bank account. Members can also select to use their bank accounts as the funding source for any transaction. Refunds that originated from a cash debit from the member's bank account may be refunded back into the member's bank account on file.

Listings 614 can be provided in virtual-currency barter network 600. Listings 614 can include an external business listing service. virtual-currency barter network 600 can interact with external listing services to enhance its internal business listings. Listings 600 can be supplemented with information from services like Yelp.com® and Yp.com®.

An example of component interaction of a virtual-currency barter network 600 is now discussed. Network Frontend 602 retrieves, updates and creates data entries in the virtual-currency barter network 600. Network Frontend 602 be used to implement all CRUD (create, read, update, delete) operations between virtual-currency barter network web sites and/or mobile device UI and Network Backend 604. Barter button 606 initiates can be used to initiate a workflow within virtual-currency barter network 600. Accordingly, Network Backend 604 then interacts with Billing module 608 according to specified transaction management workflows. Billing module 608c can update customers' data after running recurring workflows. Back-Office module 612 can implement CRUD operations on customers' profiles and their transaction history in Network Backend 604. Network Backend 604 can notify Backend 604 of new customers in the system and other events which may require account management team attention. Billing module 608 can perform operations on customers' credit cards via an external payment processor (e.g. via an external payment processor API payment service provider 610). Network Backend 604 can use third-party listings systems to populate customers' search requests within the virtual-currency barter system. In one example, virtual-currency barter network 600 can perform requests to the Yelp® API to obtain additional results for customer request “Car washing service in Los Angeles”.

To facilitate transactions between members, Network 100 may provide a set of Transaction Tools to its members such as offering partial trade and partial cash transactions. These Transaction Tools can reside and function online, in mobile devices, via installed apps, or within the member's account held by the Network 100. These Transaction Tools can be in the form of, but not limited to a Barter button that may be implemented using a snippet of code installed on a selling member's online or mobile store front, or in the form of pre-setup integrations with shopping cart software used by the selling member. Members may utilize the Transaction Tool to make purchases in the form of Trade Dollars or partial cash/partial Trade Dollars.

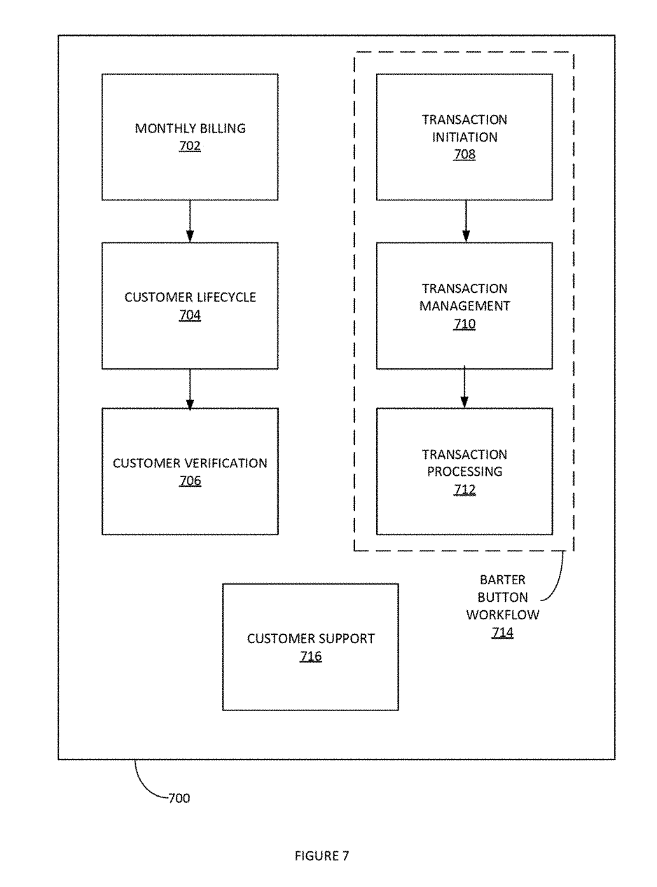

FIG. 7 illustrates an example set of workflows 700 of a virtual-currency barter network, according to some embodiments. Workflows 700 can include various operational workflows, inter alia: Monthly billing 702, Customer lifecycle 704, Barter button workflow 714 (e.g. Transaction initiation 708, Transaction management 710, Transaction processing 712), etc. Workflows 700 can include supporting workflows, including, inter alia: Customer verification 706, Customer support 716, etc. Monthly billing 702 can describe a customer's monthly billing operations and/or activities. Monthly billing 702 can invoke Customer lifecycle 704. Customer lifecycle 704 can handle customer transition between states. Customer lifecycle 704 can invoke Customer verification 706. Barter button workflow 714 can include Transaction initiation 708, Transaction management 710 and Transaction processing 712. Transaction initiation 708 can be initiated when a virtual Barter button is clicked. Transaction initiation 708 can invoke Transaction management 710. Transaction management 710 can describe how virtual-currency barter network handles each transaction between a Seller and a Buyer. Transaction management 710 can invoke Transaction processing 712. Transaction processing 712 can provide a description of how the transaction is implemented. Transaction processing 712 can handle cash and money distribution (e.g. using a Buying workflow, etc.).

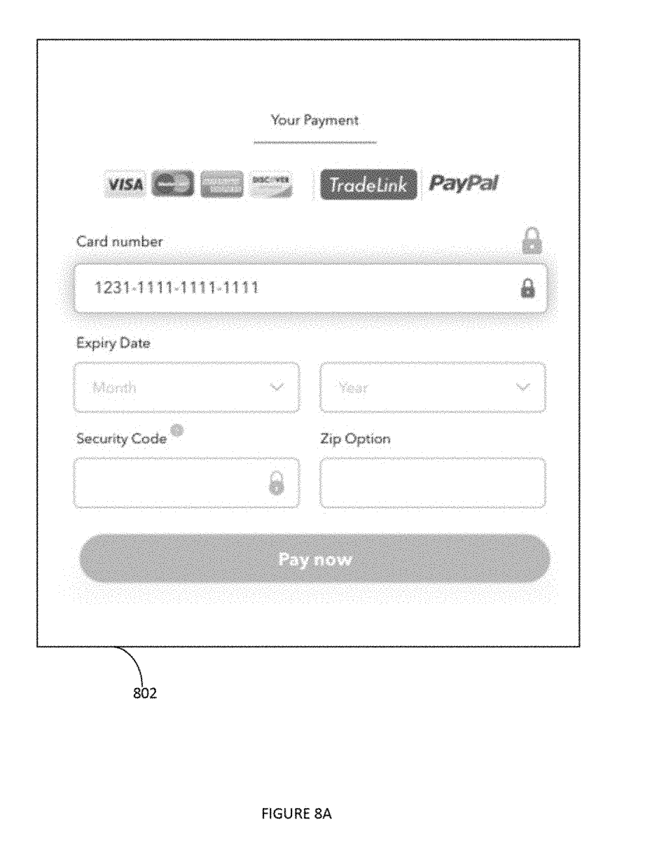

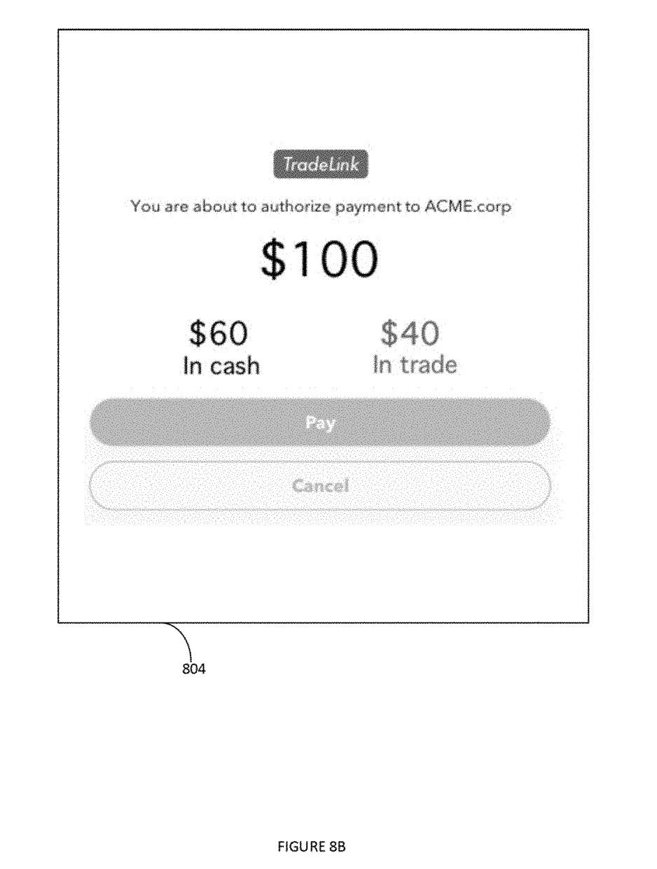

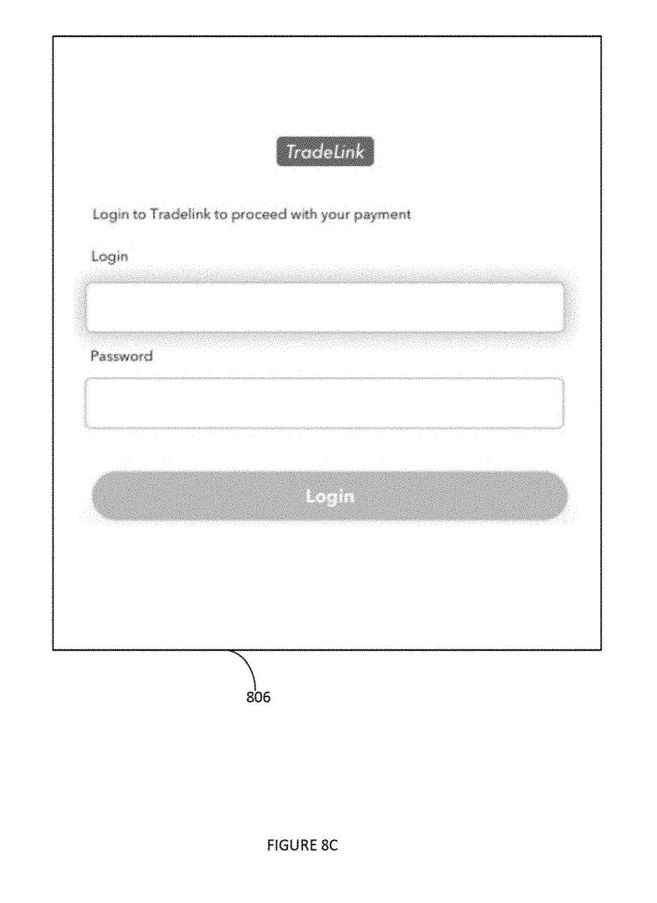

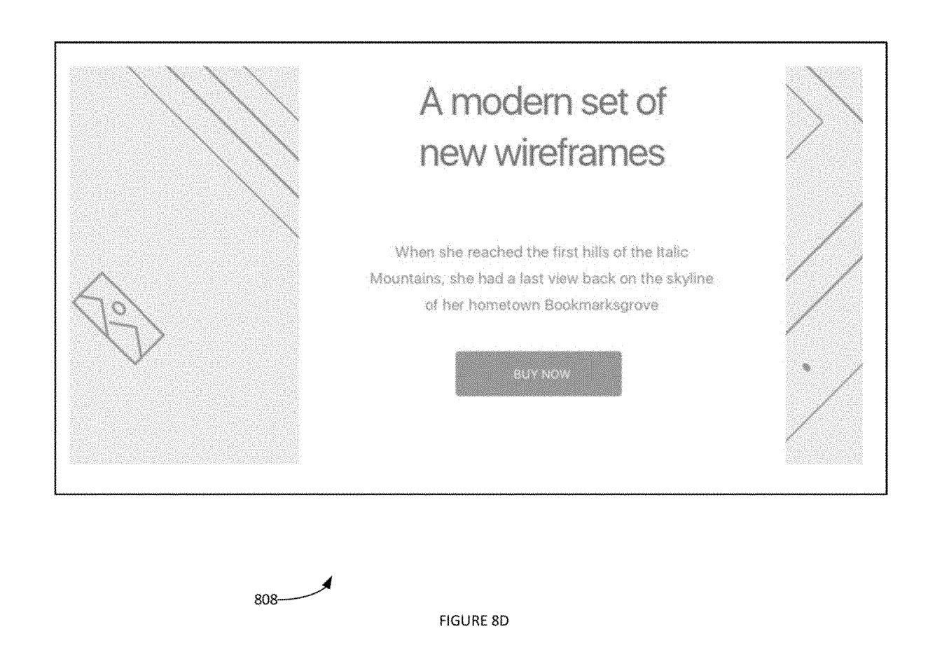

FIGS. 8 A-D illustrate an example set of screen shots 802-808 of Barter buttons, according to some embodiments. A Barter button can be distributed as a code snippet that is integrated into a company (or other entity's website) and/or other interactive visual display (e.g. a mobile device application, etc.). A Barter button can be distributed as a plugin for e-commerce platforms. A Barter button can be a part of an application and/or customer account. Barter button use cases can include a payment alternative to PayPal®, credit cards, wire transfers, etc. A Barter button can be made available via a customer-acquisition channel when a prospect customer wishes to access a hybrid virtual currency/cash payment option. More specifically, FIGS. 8A-C illustrates a series of steps that can be taken using a Barter button implemented by Network 100. In FIG. 8A, the box on the left can include an option to select Network 100 (e.g. titled “TradeLink”). This can be provided as an alternative to traditional credit card and/or PayPal® payment options. In this example, the Barter button can be provided as a plugin to an ecommerce platform. In the present example, the ability to select “TradeLink” (a virtual-currency barter network, etc.) can be provided on the payment screen displayed to a customer. FIG. 8B shows a possible result of having selected the “TradeLink” option followed by the “Pay Now” button. The box of FIG. 8B can present an option for the customer to login to virtual-currency barter network 100. In one alternative example, if the customer has already logged-in, the middle box can be skipped and/or truncated in a manner that indicates that the login has already been performed. In another example, the box of FIG. 8B can provide an option for the customer to retrieve some portion of the customer's login information. The box of FIG. 8C can indicate that after the login is complete, the payment platform may indicate the transaction total, as well as the split between cash and T$ and an option to pay or cancel. In this instance, the ratio of cash to T$ is 60:40, but it is anticipated that different values could be used and, potentially, the interactive display may permit the customer to vary the ratio in real-time according to limitations provided by Network 100 and/or the Seller. In FIG. 80, the screen shot image provides an example of the appearance of one embodiment of a Barter button.

FIG. 9 illustrates an example table 900 with input parameters for managing a Barter button workflow, according to some embodiments. It is noted that the workflow of a Barter button can be initiated by clicking on a virtual Barter button on customer web-site and/or during e-commerce checkout process. In some examples, a Barter button's input parameters can include a unique identifier: ‘Seller_id’. This can be a Customer identifier used in Network 100. Another input parameter can be a list of ‘Order_items’. This can be a list of items/hours of work for placed order. Another input parameter can be a float variable of ‘Order_fee’. This can be a payment fee for services/goods the buyer places an order for.

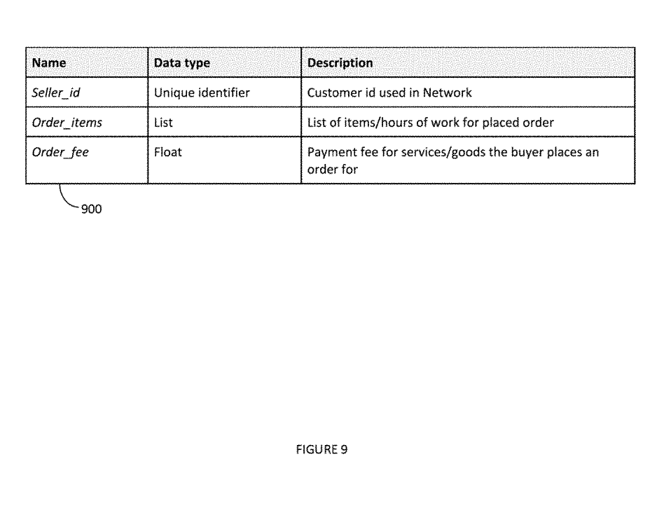

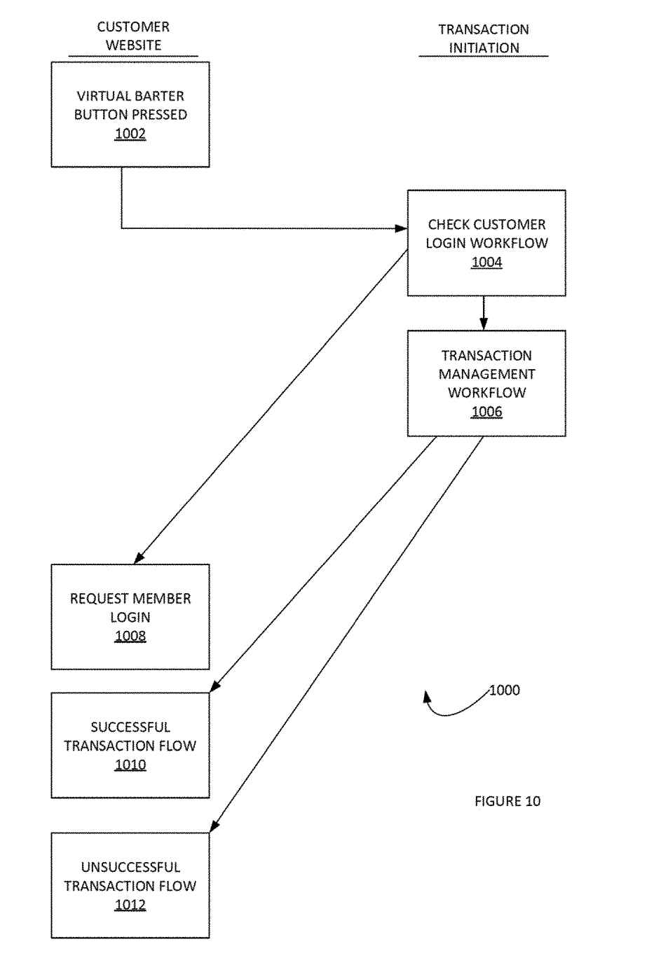

FIG. 10 illustrates an example Barter button workflow 1000, according to some embodiments. In step 1002, a virtual Barter button can be clicked on. The virtual Barter button can be located on a customer's website. The Barter button code can cause possible purchase details (along with customer details and/or order sum) to be sent to Network 100. Workflow 1000 can be transferred to a transaction initial workflow in Network 100. In step 1104, the transaction initial workflow can check customer login workflow. If the customer's login to Network 100 was unsuccessful then workflow 1000 can proceed to request member login 1008. Otherwise, if the customer's login was successful, workflow 1000 can continue to transaction management workflow 1006. It can then be determined if the transaction was successful. It the transaction was successful, then workflow 1000 can proceed to successful transaction flow 1010. If the transaction was not successful then workflow 1000 can proceed to unsuccessful transaction flow 1012.

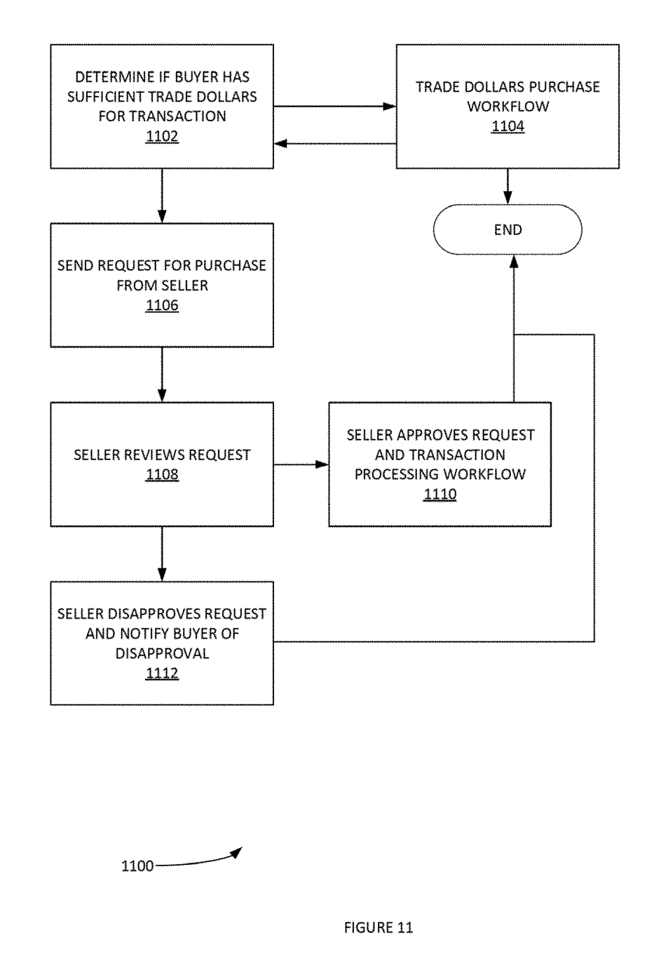

FIG. 11 illustrates an example transaction management workflow 1100, according to some embodiments. Workflow 1100 shows orchestration, in an example embodiment, of a transaction between Buyer and Seller starting from its initiation. In one example, workflow 1100 can be initiated by a Buyer in Network 100 and/or from a Barter button outside Network 100. In step 1102, workflow 1100 can determine if buyer has sufficient trade dollars for transaction. If there are not sufficient trade dollars for transaction, then, in step 1104, workflow 1100 can implement a trade dollars purchase workflow. If a member purchases sufficient trade dollars then workflow 1100 can return to step 1102. If the member does not purchase sufficient trade dollars, the workflow 1100 can end.

In step 1106, workflow 1100 can send request for purchase from seller. In step 1108, the seller can review the request. In step 1110, the seller approves request and transaction processing workflow. In step 1112, the seller disapproves request and notify buyer of disapproval.

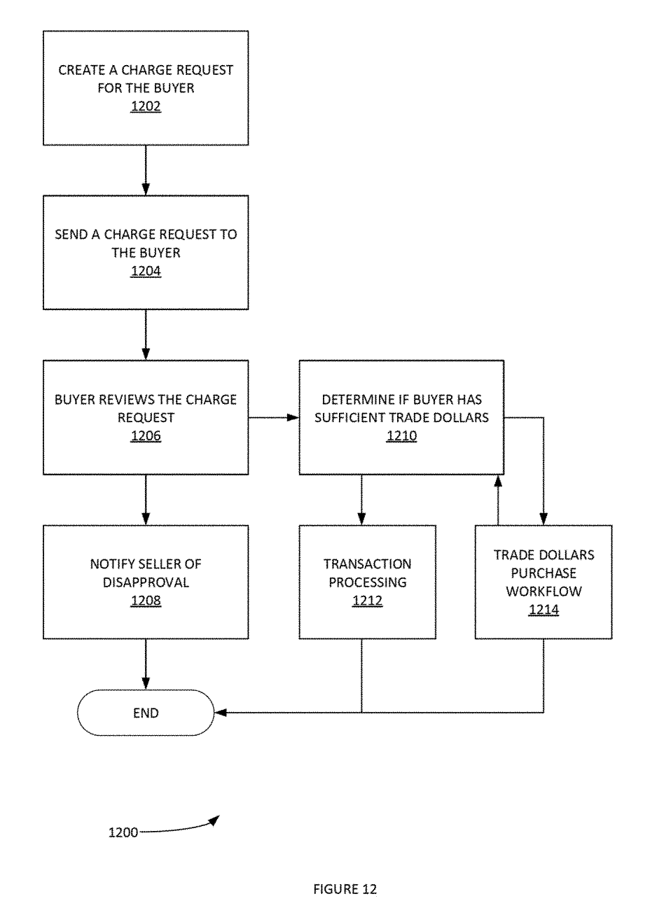

FIG. 12. Illustrates an example transaction management flow 1200, according to some embodiments. In step 1202, workflow 1200 can create a charge request for the buyer. In step 1204, workflow 1200 can send a charge request to the buyer. In step 1206, workflow 1200 can buyer reviews the charge request. In step 1208, workflow 1200 can notify seller of buyer's disapproval. In step 1210, workflow 1200 can determine if buyer has sufficient trade dollars. In step 1212, workflow 1200 can implement a transaction processing workflow. In step 1214, workflow 1200 can implement trade dollars purchase workflow. If the member purchase sufficient trade dollars, then workflow 1200 can return to step 1210. If the member does not purchase sufficient trade dollars, then workflow 1200 can end.

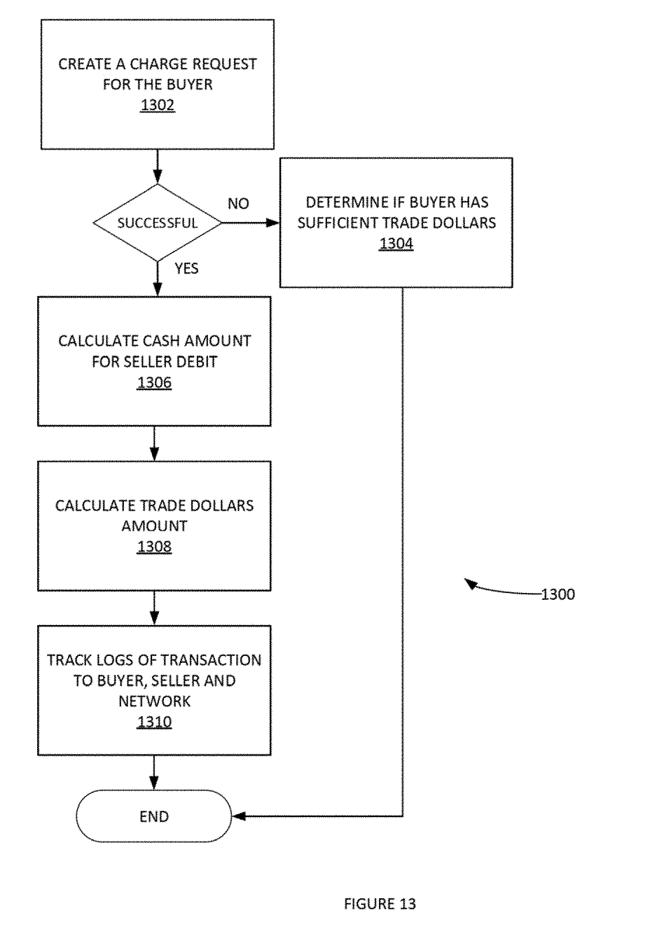

FIG. 13 illustrates another example transaction processing workflow 1300, according to some embodiments. In step 1302, workflow 1300 can create a charge request for the buyer. If the charge request is not successful, then in step 1304, workflow 1300 can determine if buyer has sufficient trade dollars. If the charge request is successful, then in step 1306, workflow 1300 can calculate cash amount for seller debit. In step 1308, workflow 1300 can calculate the trade-dollars amount. In step 1310, workflow 1300 can track logs of transaction to buyer, seller and network.

It is noted that workflows 1100-1300 can be communicatively couples with online payment service provider (e.g. WePay®, etc.). Additional examples of workflows 1100-1300 are provided in U.S. Provisional Application No. 62/334,415.

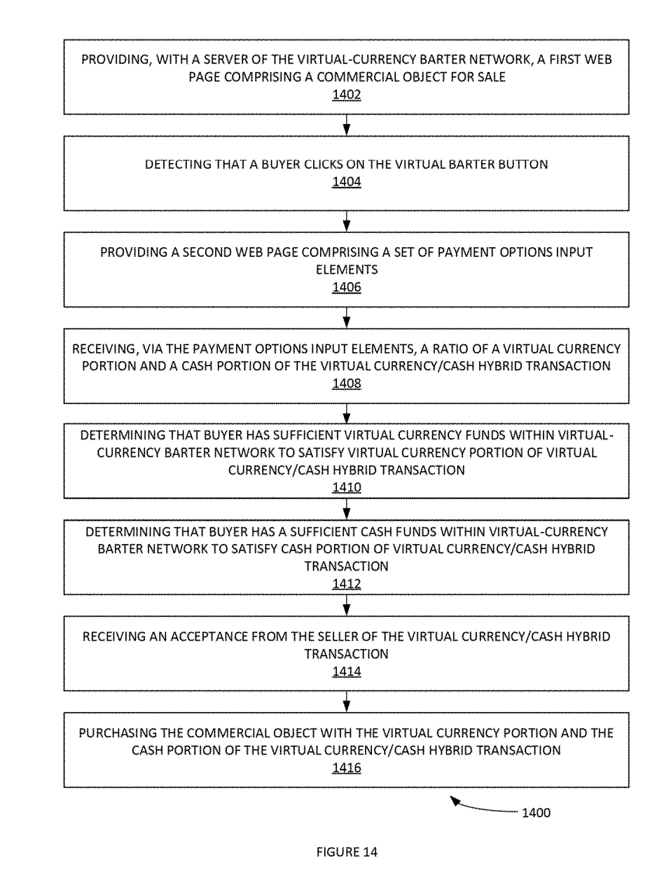

FIG. 14 illustrates an example of a virtual-currency barter network process 1400, according to some embodiments. In step 1402, process 1400 provides, with a server of the virtual-currency barter network, a first web page comprising a commercial object for sale, wherein the commercial object is purchasable using a virtual currency/cash hybrid transaction, and wherein the web page comprises a virtual barter button. In step 1404, process 1400 detects that a buyer clicks on the virtual barter button. In step 1406, process 1400 provides a second web page comprising a set of payment options input elements. In step 1408, process 1400 receives, via the payment options input elements, a ratio of a virtual currency portion and a cash portion of the virtual currency/cash hybrid transaction. In step 1410, process 1400 determines that the buyer has sufficient virtual currency funds within the virtual-currency barter network to satisfy the virtual currency portion of the virtual currency/cash hybrid transaction. In step 1412, process 1400 determines that the buyer has a sufficient cash funds within the virtual-currency barter network to satisfy the cash portion of the virtual currency/cash hybrid transaction. In step 1414, process 1400 receives an acceptance from the seller of the virtual currency/cash hybrid transaction. In step 1416, process 1400 purchasing the commercial object with the virtual currency portion and the cash portion of the virtual currency/cash hybrid transaction.

It is noted that, in some embodiments, a Seller can have an option to accept or deny an attempt by the Buyer to purchase a good and/or service. The Seller can manually accept and/or automatically provide a set of acceptance parameters in the event that a Buyer's offer fits a pre-defined ratio of virtual currency to cash. Network 100 can automatically check to determine that the Buyer has sufficient trade dollars (and/or other virtual currency credits, etc.) for the transaction. Network 100 can then determine that the Buyer has a line of credit to fulfill a cash portion of the virtual currency/cash hybrid transaction. If the Buyer has sufficient funds from both portions of the virtual currency/cash hybrid transaction then Network 100 can communicate the offer to the Seller.

Trade dollars can be used as a form of a microloan to Network 100 from a Seller. For example, the virtual currency portion of the virtual currency/cash hybrid transaction can be a microloan on a portion of the value of the good or service for sale. Trade dollars can also be provided by employers to employees to barter for goods and/or services in Network 100. For example, employers can provide hybrid bonuses and/or salaries to employees in the form a virtual currency/cash payment.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A system useful in a virtual-currency barter network provider serving a web page offering a commercial opportunity using a partial virtual currency and partial cash payment, the system comprising:
(a) a computer store comprises data, for a web page, defining a plurality of visually perceptible elements, which visually perceptible elements correspond to the web page, wherein at least one of the visually perceptible elements comprises a code snippet for at least one barter button active link, and wherein the computer store comprises a virtual currency amount of a buyer;
(i) wherein the first web page belongs to and is served by a virtual-currency barter network; and
(ii) wherein the web page displays the at least one barter button active link associated with a commerce object associated with a buying opportunity of a seller in a virtual currency/cash hybrid transaction;
(b) a computer server at the virtual-currency barter network provider, which computer server is coupled to the computer store and programmed to:
(i) receive from the web browser of a computer of the buyer a signal indicating activation of one of the at least one barter button active link displayed by one of the first web pages;
(ii) receive from the web browser of the computer of the buyer another signal indicating a virtual currency portion and a cash portion of the virtual currency/cash hybrid transaction;
(iii) in response to receiving the signal indicating activation of one of the at least one barter button active link and to receiving the virtual currency portion and the cash portion of the virtual currency/cash hybrid transaction, automatically communicate the indicated virtual currency portion and the cash portion to the seller;
(iv) in response to receiving the signal indicating activation of one of the at least one barter button active link:
(A) determine that the buyer has sufficient virtual currency funds within the virtual-currency barter network to satisfy the virtual currency portion of the virtual currency/cash hybrid transaction;
(B) determine that the buyer has a sufficient cash funds within the virtual-currency barter network to satisfy the cash portion of the virtual currency/cash hybrid transaction;
(v) automatically receive an acceptance of the seller for the indicated virtual currency portion and the cash portion; and
(vi) using the acceptance of the seller retrieved to automatically generate and transmit to the web browser a second web page that displays:
(A) information associated with the commerce object,
(B) the virtual currency portion and the cash portion of the virtual currency/cash hybrid transaction, and
(C) another indication that the virtual currency/cash hybrid transaction has been completed; and
(vii) using the retrieved acceptance of the seller to automatically deduct the virtual currency portion from the virtual currency amount of a buyer in the computer store; and
(viii) using the retrieved acceptance of the seller to automatically implement an electronic cash payment transaction with an online payment service provider.

2. The system of claim 1, wherein the commerce object comprises a good for sale in the virtual-currency barter network.

3. The system of claim 1, wherein the commerce object comprises a service for sale in the virtual-currency barter network.

4. The system of claim 1, wherein a ratio of the indicated virtual currency portion and the cash portion is manually set by the buyer.

5. The system of claim 1, wherein the signal indicating activation comprises a clicking on a virtual barter button displayed on the first web page.

6. A computerized method of a virtual-currency barter network comprising:
providing, with a server of the virtual-currency barter network, a first web page comprising a commercial object for sale, wherein the commercial object is purchasable using a virtual currency/cash hybrid transaction, and wherein the web page comprises a virtual barter button;
detecting that a buyer clicks on the virtual barter button;
providing a second web page comprising a set of payment options input elements;
receiving, via the payment options input elements, a ratio of a virtual currency portion and a cash portion of the virtual currency/cash hybrid transaction;
determining that the buyer has sufficient virtual currency funds within the virtual-currency barter network to satisfy the virtual currency portion of the virtual currency/cash hybrid transaction;
determining that the buyer has a sufficient cash funds within the virtual-currency barter network to satisfy the cash portion of the virtual currency/cash hybrid transaction;
receiving an acceptance from the seller of the virtual currency/cash hybrid transaction; and
purchasing the commercial object with the virtual currency portion and the cash portion of the virtual currency/cash hybrid transaction.

7. The computerized method of claim 6 further comprising:
implementing the payment of the cash portion of the virtual currency/cash hybrid transaction through an online payment service provider.

8. The computerized method of claim 6, wherein the virtual currency portion of the virtual currency/cash hybrid transaction is handled by the virtual-currency barter network.

9. The computerized method of claim 6, wherein the commerce object comprises a good for sale in the virtual-currency barter network.

10. The computerized method of claim 6, wherein the commerce object comprises a service for sale in the virtual-currency barter network.

11. The computerized method of claim 6, wherein a ratio of the indicated virtual currency portion and the cash portion is manually set by the buyer via an input element displayed on the second web page.

12. A system useful in a trade-dollar currency/cash barter network provider serving a web page offering a commercial opportunity using a partial trade-dollar currency and partial cash payment, the system comprising:
(a) a computer store comprises data, for a web page, defining a plurality of visually perceptible elements, which visually perceptible elements correspond to the web page, wherein at least one of the visually perceptible elements comprises a code snippet for at least one barter button active link, and wherein the computer store comprises a trade-dollar currency amount of a buyer;
(i) wherein the first web page belongs to and is served by a trade-dollar currency/cash barter network; and
(ii) wherein the web page displays the at least one barter button active link associated with a commerce object associated with a buying opportunity of a seller in a trade-dollar currency/cash hybrid transaction;
(b) a computer server at the trade-dollar currency/cash barter network provider, which computer server is coupled to the computer store and programmed to:
(i) receive from the web browser of a computer of the buyer a signal indicating activation of one of the at least one barter button active link displayed by one of the first web pages;
(ii) receive from the web browser of the computer of the buyer another signal indicating a trade-dollar currency portion and a cash portion of the trade-dollar currency/cash hybrid transaction;
(iii) in response to receiving the signal indicating activation of one of the at least one barter button active link and to receiving the trade-dollar currency portion and the cash portion of the trade-dollar currency/cash hybrid transaction, automatically communicate the indicated trade-dollar currency portion and the cash portion to the seller;
(iv) in response to receiving the signal indicating activation of one of the at least one barter button active link:
(C) determine that the buyer has sufficient trade-dollar currency funds within the trade-dollar currency/cash barter network to satisfy the trade-dollar currency portion of the trade-dollar currency/cash hybrid transaction;
(D) determine that the buyer has a sufficient cash funds within the trade-dollar currency/cash barter network to satisfy the cash portion of the trade-dollar currency/cash hybrid transaction;
(v) automatically receive an acceptance of the seller for the indicated trade-dollars currency portion and the cash portion; and
(vi) using the acceptance of the seller retrieved to automatically generate and transmit to the web browser a second web page that displays:
(A) information associated with the commerce object,
(B) the trade-dollar currency portion and the cash portion of the trade-dollar currency/cash hybrid transaction, and
(C) another indication that the trade-dollar currency/cash hybrid transaction has been completed.

13. The system of claim 12, wherein the computer server is programmed to:
use the retrieved acceptance of the seller to automatically deduct the trade-dollar currency portion from the trade-dollar currency amount of a buyer in the computer store.

14. The system of claim 13, wherein the computer server is programmed to:
use the retrieved acceptance of the seller to automatically implement an electronic cash payment transaction with an online payment service provider.

15. The computerized method of claim 12, wherein the commerce object comprises a good for sale in the trade-dollar currency/cash barter network.

16. The computerized method of claim 12, wherein the commerce object comprises a service for sale in the trade-dollar currency/cash barter network.

17. The computerized method of claim 12, wherein a ratio of the indicated virtual currency portion and the cash portion is set by the trade-dollar currency/cash barter network.
